(19) United States
(12) Patent Application Publication
(10) Pub. No.: US 2015/0173411 A1
(43) Pub. Date: Jun. 25, 2015

(54) Apparatus and Method for Disinfection of Packaged Articles

(71) Applicant: OZONICA LIMITED, Northamptonshire (GB)

(72) Inventor: Malcolm Robert SNOWBALL, Northamptonshire (GB)

(21) Appl. No.: 14/499,751

(22) Filed: Sep. 29, 2014

Related U.S. Application Data
(63) Continuation of application No. PCT/GB2013/005081, filed on Mar. 27, 2013.

(30) Foreign Application Priority Data
Mar. 29, 2012 (GB) 1205611.5

(51) Int. Cl. A23L 3/32; A23L 3/00; A23L 3/10

(52) U.S. Cl. CPC A23L 3/32; A23L 3/10; A23L 3/001; A23V 2002/00

(57) ABSTRACT

Disclosed are packet sterilisers for sterilising packaged articles. Some such packet sterilisers comprise: a working surface arranged for receiving a packaged article to be sterilised; a first electrode and a second electrode; wherein the first electrode and the second electrode extend behind a portion of the area of the working surface and the first electrode is disposed between the second electrode and the working surface and the first electrode comprises a plurality of gaps arranged so that, in use, when a voltage difference is applied between the first electrode and the second electrode, the associated electric field is able to extend through the gaps beyond the working surface and into a package of said packaged article to be sterilised, wherein the first electrode and the second electrode comprise adjacent extended surfaces which lie substantially along the direction of the working surface that provides a capacitance related to the adjacent spatial extent of the first electrode and the second electrode and an inductance is provided, wherein the inductance is selected based on that spatial extent to modify the resonant frequency of the electrode arrangement.

### CROSS-REFERENCE TO RELATED APPLICATIONS

This application is a continuation of pending International Application No. PCT/GB2013/050810 filed on Mar. 27, 2013, which designates the United States and claims priority from Great Britain Application No. 1205611.5 filed on Mar. 29, 2012, both of which are incorporated by reference in their entireties.

### BACKGROUND

1. Field of Invention

This invention relates to a method and apparatus for the disinfection of packaged articles such as packaged food and drink products. The invention also relates to apparatus for generating plasma for this purpose, and to related electrical systems and configurations of electrodes and their methods of use for the sterilisation or disinfection of packaged articles.

2. Related Art

International Patent application WO2010/116191 discloses a plasma-generating apparatus and method in which two electrodes are arranged so that, upon the application of a sufficiently high voltage, the electromagnetic field between the electrodes creates cold plasma energetic enough to convert oxygen in air into ozone and other reactive oxygen based species. Further work by the same inventor has provided a variety of practical configurations of electrodes.

Two electrodes arranged in this way behave as a capacitor. In some arrangements the two electrodes may have a planar configuration and be arranged with a spacing between the two major surfaces of these planar electrodes. Gaps or holes in one (or both) of the electrodes allows electric field to “leak” from between the plates. Under suitable conditions this electric field leakage can be used to generate plasma. Whilst this arrangement may have some advantages, arrangements like this have particularly high capacitance.

### SUMMARY

The inventor in this case has recognised that, where electrodes are arranged in this way their capacitance may compromise the efficiency of power transfer to and from the electrodes, not least because substantial power is used to establish and maintain the electric field between the plates. In practical commercial systems power consumption is a significant process cost. It is also desirable to improve efficiency for environmental purposes.

Aspects and examples of the invention are directed to these issues as set out in the appended claims.

The inventors in the present case have found that it is advantageous to drive the electrodes for these systems using high frequency alternating currents, for example in the radio frequency range and although it is somewhat counterintuitive, it is advantageous to include an inductive load with the capacitive electrodes. Although, where high frequency voltages are present the presence of inductance in the circuit would ordinarily be considered a disadvantage, examples of the invention enable resonant or sub-resonant operation of the electrodes. In essence the electrodes of the plasma generation apparatus can be treated as if they are part of an LCR resonant tank circuit and this is found to offer operational benefits in practical systems.

In an aspect there is provided a packet steriliser for sterilising packaged articles, comprising: a working surface arranged for receiving a packaged article to be sterilised; a first electrode, and a second electrode wherein the first electrode and the second electrode extend behind a portion of the area of the working surface and the first electrode is disposed between the second electrode and the working surface and the first electrode comprises a plurality of gaps arranged so that, in use, when a voltage difference is applied between the first electrode and the second electrode, the associated electric field is able to extend through the gaps beyond the working surface and into a package of said packaged article to be sterilised, wherein the first electrode and the second electrode comprise adjacent extended surfaces which lie substantially along the direction of the working surface that provides a capacitance related to the adjacent spatial extent of the first electrode and the second electrode and an inductance is provided, wherein the inductance is selected based on that spatial extent to modify the resonant frequency of the electrode arrangement.

In an embodiment the packet steriliser comprises a dielectric arranged between the first electrode and the second electrode, the dielectric having a breakdown voltage of at least 20 kV per mm, preferably at least 30 kV per mm. In some embodiments the dielectric is selected from a list comprising: boron nitride; shapal; mica; and synthetic mica such as synthetic flourophlogopite.

In some embodiments at least one of the first electrode and the second electrode comprises the inductance, but in other embodiments separate inductances may be provided. In some cases the at least one of the first electrode and the second electrode comprises a coil. The term “coil” should not necessarily be taken to imply a circular cross section. Typically a flattened, substantially rectangular cross section will be used but although advantageous, this is optional.

Preferably the inductance is selected based on the spatial extent and/or capacitance of the electrodes to modify the resonant frequency of the electrode arrangement. This modification may be selected to tune the electrode impedance to improve power transfer to the electrodes. The inductance may be provided by the coiled electrodes. In some cases a separate inductance is provided either in addition to or as an alternative to the electrode itself being coiled. Whilst it is advantageous for the electrode to comprise the inductance this is not essential and the inductance may be provided elsewhere in the system.

In some embodiments the at least one electrode is arranged to provide a conductive path which traverses the extended surface of the at least one electrode to provide at least a part of said inductance. To this end, the conductive path may be zig-zag serpentine or coiled so that it repeatedly traverses the extended surface. The terms zig-zag, serpentine and coiled are intended to include any arrangement in which a path folds and/or bends back on itself repeatedly. In some embodiments the electrode is serpentine in form or coiled to provide said conductive path.

In some embodiments the at least one electrode comprises the first electrode and the conductive path is arranged to traverse the working surface between said gaps. Preferably at least one of the first and second electrodes comprises a planar insulator and a conductive material arranged to provide a conductive path along the surface of said insulator and the conductive material may be arranged in a plurality of strips, for example in which the plurality of strips are conductively coupled at alternate ends. Coupling at alternate ends may be done in such a way as to provide a folded, zig-zag or serpentine conductive path.

In some embodiments the conductive material comprises a layer and the layer is etched to provide the strips. In some embodiments the layer is deposited on or fixed to said insulator. In some embodiments both major surfaces of the insulator comprise strips of conductive material. The strips may be substantially parallel to each other and may be arranged on opposite surfaces of the insulator. Where the strips are arranged on opposite sides of the are conductively coupled through the insulator at alternate ends of the strips to provide a coiled conductive path which traverses alternate surfaces of the insulator as it traverses the extended surface of the electrode.

Preferably the strips on the second electrode are arranged so that strips on opposite surfaces of the insulator overlap.

Preferably at least some of the strips on the first electrode are arranged so that strips on opposite surfaces of the insulator do not overlap, thereby to provide said gaps. Preferably at least one of the electrodes is provided by an insulated wire arranged as a flattened coil. Preferably the inductance is adjustable and the packet steriliser may comprise a plurality of conductive elements for adjusting the inductance. For example the conductive elements comprise voltage controlled impedances such as transistors.

The packet steriliser may comprise an additional capacitance coupled in series with one of said electrodes and preferably the capacitance is integrated with the electrodes in a single unit.

Preferably the second electrode is earthed and the first electrode is covered with an insulator. This and other examples of the invention have the advantage of providing improved safety because the second electrode (e.g. the electrode having the gaps) need not be insulated and the inventors have found that this enables a plasma to be established in the packaged article using a lower applied voltage than would otherwise be required for an insulated electrode (i.e. a non-insulated electrode allows a lower plasma strike voltage).

Embodiments of the invention include a method of sterilising a packaged article comprising arranging a packaged article adjacent the working surface of a packet steriliser according to any preceding claim and applying a voltage to said electrodes to generate ozone in said package.

### BRIEF DESCRIPTION OF THE DRAWINGS

Embodiments of the invention will now be described, by way of example only with reference to the accompanying drawings, in which:

FIG. 1 shows a general schematic view of an apparatus for generating ozone inside packaged articles;

FIG. 2 shows a representation of a packaged article adjacent to a capacitive head connected to a power supply in which the components are represented by simplified equivalent electrical circuits;

FIG. 3 shows a plan view of an electrode with a part section view inset;

FIG. 4 shows a plan view of another electrode;

FIG. 5 shows a section through a part of an electrode head comprising an electrode such as that shown in FIG. 3 and a second electrode such as that shown in FIG. 4;

FIG. 6 illustrates a possible modification of the electrodes;

FIG. 7 shows a section through a part of an electrode head;

FIG. 8 shows another section through a part of an electrode head; and

FIG. 9 shows another section through a part of an electrode head.

### DESCRIPTION OF ILLUSTRATIVE EMBODIMENTS

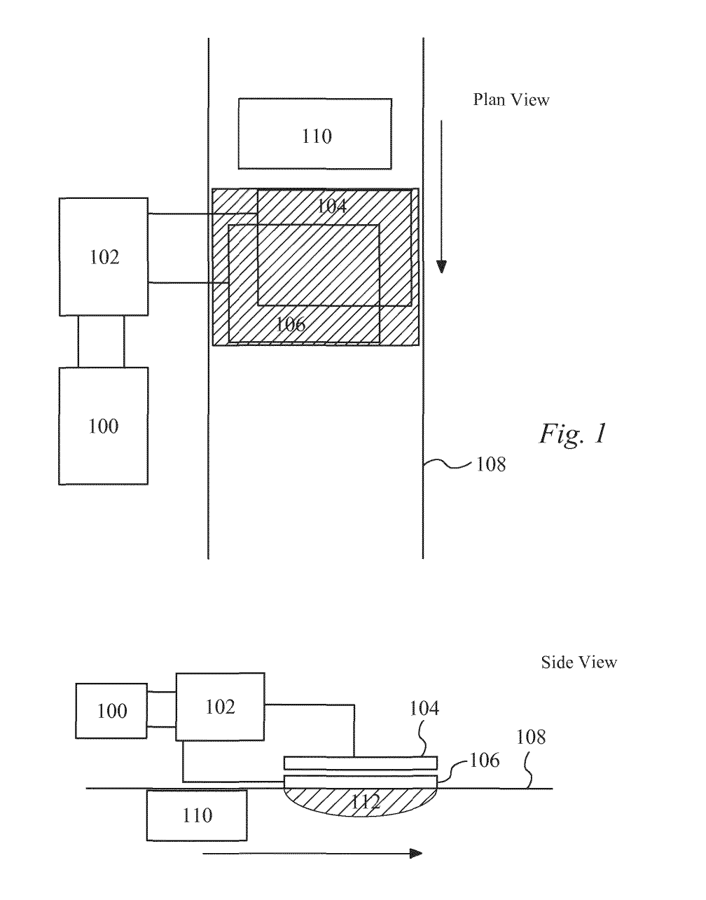

In overview, methods and apparatus of the invention are generally employed in systems substantially similar to that shown in FIG. 1.

In FIG. 1 the packet sterilising apparatus 1000 comprises: a power supply 100, an impedance matcher 102 and an electrode head comprising first and second electrodes 104, 106. A conveyor 108 carries packaged articles 110 into a position within the electric field 112 produced by the electrodes.

In operation, a packaged article 110 is carried by the conveyor 108 to a position adjacent the electrode head 104, 106. The electrode head 104, 106 is energised by the power supply 100, 102 with a high frequency AC voltage to create an electric field 112 around the electrodes. The electric field penetrates the packaged article and by applying a sufficiently high voltage and/or frequency a cold plasma can be generated within the package 110. If the package contains oxygen, this plasma has been found to generate ozone and other reactive species and this is thought to reduce the number of food spoilage organisms in the packages and so increase the shelf life of the food.

The drawing of FIG. 1 is merely schematic, although arranged in accordance with the same general principals, practical systems will be arranged in a variety of different ways. For example, for clarity the electrodes 104, 106 are shown side by side as if they are separate physical structures. This need not be the case and (as will be explained below) the electrodes may be arranged one on top of another and/or provided by parts of the same physical structure, or provided separately.

As shown in FIG. 1 it is preferable if the apparatus is configured so that, in use a packaged article is applied beneath the electrode head. In this way the contents of the pack are held away from the electrode (at the bottom of the pack) by gravity and there is an air space adjacent the electrode inside the pack. This has the advantage that the plasma is formed in the air gap and the food (or other contents of the package) are not subjected to the electric field and do not interfere with the creation of a plasma.

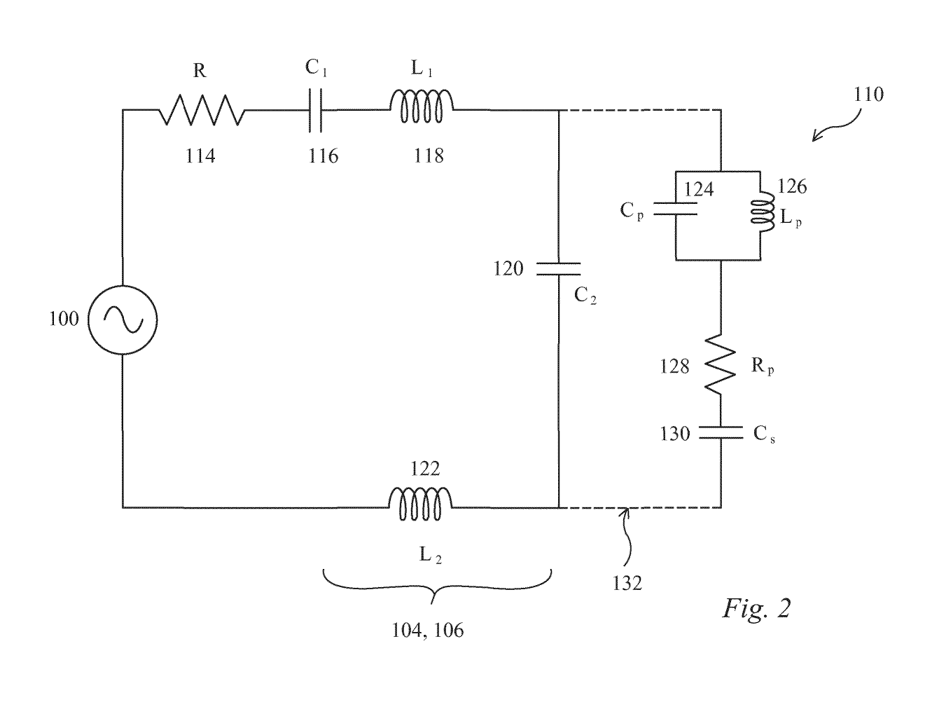

The structure of the electrodes and their electrical configuration will be described in greater detail below with reference to FIGS. 2 to 9. In summary, the electrodes are coils wound in a flat configuration which introduces a degree of inductance into the electrodes.

The matching impedance 102 may include a series capacitance which reduces the apparent capacitance of the electrode head, 104, 106. The electrodes are not generally conductively coupled to one another so the electric circuit is, in effect, completed via the electric field generated between the flat coils as if the electrode head 104, 106 were simply a large capacitor. If the coils are wound in the same direction, e.g. right hand wound and then positioned so that they oppose each other (coil drive connection at the left hand side of one electrode coil 104 and at the right hand side of the other electrode coil 106) then a current flowing through the coil combination always sees the same impedance anywhere across the electrode coil pair 104, 106. The capacitive, inductive and resistive impedance of the electrodes is distributed across the electrodes.

The power supply typically has a voltage output range of 6 kV to 18 kV peak, a maximum current output of 15 mA and a working frequency range of 1 kHz to 80 kHz. The power output of the power supply is typically in the range of 10 to 500 Watts per head (per pair of electrodes). The output impedance of the power supply is approximately 30 Ohms. Other types of power supply may be used. To generate cold plasma a voltage of at least 7 kV peak (e.g. peak to peak) is preferentially used at a frequency of 40 kHz but these values are merely preferred examples and should not to be construed as limiting. The conveyor may be a conveyor belt or any other means of bringing the packaged articles into range of the electric field 112. In some cases the electrodes 104, 106 may be movable and so they can be moved into range of the packaged article 110. The conveyor is optional and portable electrode systems are contemplated, this is discussed in more detail below. Likewise the power supply is generally ancillary and, examples of the invention need only be couplable to a power supply—the power supply itself can be provided separately.

FIG. 2 shows a simplified electrical representation of the physical configuration in FIG. 1 in which the electrodes are flat wound coils. In this representation, the apparatus of FIG. 1 comprises the AC power supply 100, a series resistance, 114, of R Ω and a series capacitance, 116, of C1 farad. Also in this representation, when the apparatus is in use, the packaged article 110 contains a region of plasma in the electric field 112 and so comprises some plasma capacitance 124 of Cp farad and some plasma inductance 126, Lp henry. There is also some series resistance 128, Rp Ω associated with the plasma and some small capacitance Cs which occurs due to the plasma acting as a virtual electrode.

The first flat wound coil electrode 104 of FIG. 1 comprises an inductance 118 as shown in FIG. 2. This inductance is L1 henry. Likewise the inductance of the second flat wound coil electrode 106 is represented in FIG. 2 by the inductance 120. This inductance is L2 henry. The arrangement of electrodes 104, 106 together creates a capacitance C2 farad between the electrodes and this is represented by capacitance 120 in FIG. 2. Typical values for these inductances and capacitances are C1=600 nF, L1=2.30, L2=1.8 μH.

The inductance 118 is coupled in series with the capacitance 120 which in turn is coupled in series to the capacitance 122. The inductance 122 is coupled in series between the power supply 100 and the capacitance 120.

In the packaged article 110 the plasma capacitance 124 can be thought of as being coupled in parallel to the plasma inductance 126. This parallel LC circuit is coupled in series to the series resistance 128 associated with the plasma and a small capacitance 130 which occurs due to the plasma acting as a virtual electrode. The dotted lines 132, 134 indicate the existence of a capacitive (and slight inductive) coupling between the electrodes 104, 106 and the packaged article 110.

The total capacitance of the apparatus, C, (excluding the contribution of the packaged article which for the purposes of a first approximation can be ignored) is:

$$C = \frac{{C}_{1} {C}_{2}}{{C}_{1} + {C}_{2}} . \qquad ( 1 )$$

This provides an RLC circuit having a Q factor of:

$$Q = \frac{1}{R} \sqrt{\frac{L}{C}} , \qquad ( 2 )$$

where L=L₁+L₂+M where M is a term which accounts for the mutual inductance of the two electrodes.

The Q-factor of the circuit increases linearly as a function of the frequency, f, of the voltage applied by the power supply 100 to drive the circuit until the frequency becomes high enough to create significant skin effect in the conductors. Above this threshold frequency the resistance, R, increases as a function of the square root of frequency, e.g. proportional to \sqrt{f}. This increase in resistance causes a corresponding decrease in the circuit's Q-factor at high frequency. One advantageous example is to use a frequency of 40 kHZ in burst pulses or 0.5 seconds in length, using this application of voltage with the apparatus described herein has been found to produce ozone in useful, but not excessive quantities. Preferably three such bursts are applied to each packaged article, although the number and/or duration of the bursts may vary depending on the internal volume of the package.

Throughout this specification specific values are quoted for impedances, voltages and operating frequencies but, as will be appreciated, the nature of operating electric systems which may couple capacitively and/or inductively with adjacent structures and apparatus is that the specific values need to be tuned or “shimmed” to accommodate operating conditions encountered in practice so the values quoted should be treated as exemplary and non limiting.

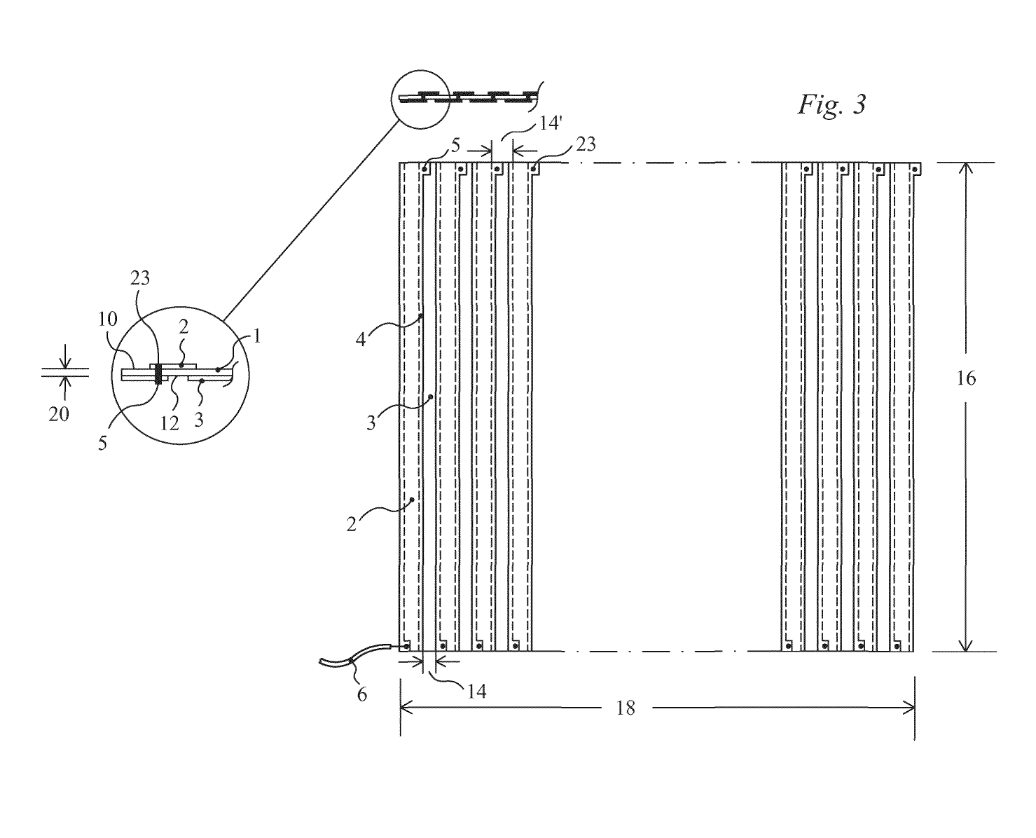

FIG. 3 shows a plan view of a flat coil electrode such as electrode 104 in FIGS. 1 and 2. The electrode is wound as a flattened coil on a substantially planar insulator 1. The insulator 1 has a first major surface 10 and a second major surface 12. The first major surface 10 and the second major surface 12 have a length 18 and a width 16 which are very much greater than the thickness 20 of the insulator, i.e. the insulator is substantially planar.

In FIG. 3 the first major surface 10 is the top surface. A plurality of elongate conducting strips 2 are carried on this top surface 10 of the insulator 1. Each strip 2 is arranged across the insulator 1 in the direction of its width 16. The strips 2 are spaced out along the first major surface 10 in the direction of its length 18. The spacing 14 between the strips is 0.25 mm to 1.5 mm. Each strip has a connector tab 5 at one of its ends which protrudes partially across the spacing 14. The strips 2 are arranged so that the connector tabs 5 all lie proximal to a first side of the first major surface 10 of the insulator 1.

In FIG. 3 the second major surface 12 is the lower surface and so is hidden in the plan view. As indicated by broken lines in the plan view of FIG. 3 (and shown in the inset) the second major surface 12 of the insulator carries a plurality of elongate conductive strips 3.

The strips 3 on the second major surface are offset from those on the first major surface so that the spacing 4 on one surface generally coincides with a strip 2, 3 on the other surface. The spacing 14, 14′ between the strips 2, 3 in the electrode shown in FIG. 3 is narrower than the strip on the opposite surface so that, in the electrode, all regions of the insulator 1 are covered on at least one surface by a conducing strip.

The strips 3 are substantially similar to the strips 2 carried on the first major surface 10 in that they extend along the width 16 direction of the insulator and are spaced apart along the length direction 18 of the insulator. The spacing 14′ of the strips 3 on the second major surface of the insulator is 0.5 mm to 1.0 mm. Each strip 3 has a connector tab 5 at one of its ends which protrudes partially across the spacing 14′.

The strips 3 are arranged so that the connector tabs 5′ all lie proximal to a second side of the second major surface 12 of the insulator 1. Thus, the tabs 5′ of the strips 3 on the second major surface 12 are at one side of the electrode, and the tabs 5 of the strips 2 on the first major surface 10 are arranged at the other side of the electrode. The effect is to provide a flat rectangular coil.

Thus, on the first major surface 10 of the insulator 1, the tabs 5 of the strips 2 are arranged along a first side of that surface 10 whilst on the second major surface 12, the tabs 5 of the strips 3 are arranged along a second side of that surface 12 so that the tabs on one surface are at the opposite side of the surface 10 from the tabs on the other 12.

Each of the tabs 5, 5′ is coupled through the insulator 1 to the strip on the other major surface by a conductive connector 23. Thus, the tabs 5 adjacent the first side of the first major surface 10 of the insulator 1, are coupled to the strips 3 on the second major surface 12. Likewise the tabs 5′ of the strips 3 on the second major surface 12 are each coupled to a respective corresponding strip 2 on the first major surface. This provides a substantially flat rectangular coil.

In other words, the construction is that of a flat coil. The thin insulator 1 has a series of thin strips 2 of a conductor applied to one of its surfaces; the strips have spaces between them. These strips form one side (e.g. the top) of a flat coil. On the other surface of the insulator 1 similar thin strips 3 of a conductor are applied and form the bottom of the flat coil. The strips 2, 3 are positioned such that the top and bottom strips overlap 4 (see inset of FIG. 3). To form a coil, a tab 5 at one end of a strip 2 is connected to the adjacent strip 3 on the opposite surface of the insulator. The other end of that strip 3 is connected back through the insulator 1 to the next adjacent strip 2 and so on. This sequence carries on until the full coil is formed. There can any number of turns to make the required inductance and the dimensions of the strips are not critical so long as the individual turns overlap and their thickness is adequate to carry the required current without creating excessive skin effects.

The insulator 1 may be a dielectric and preferably comprises a ceramic such as shapal and typically the breakdown voltage of the insulator is at least 15 kV. The insulator 1 is described as being substantially planar but need not be flat, for example the insulator could have a curved or bowed configuration. The strips 2, 3 on the first and second major surfaces may be of similar width or in some cases the strips on one of the two surfaces may be wider than the other. Typically the thickness of the strips is typically 0.05 mm to 0.1 mm and the strips comprise a metal such as copper, but other conductive materials may be used. In some examples the insulator may be a flexible material such as a plastic/polymer.

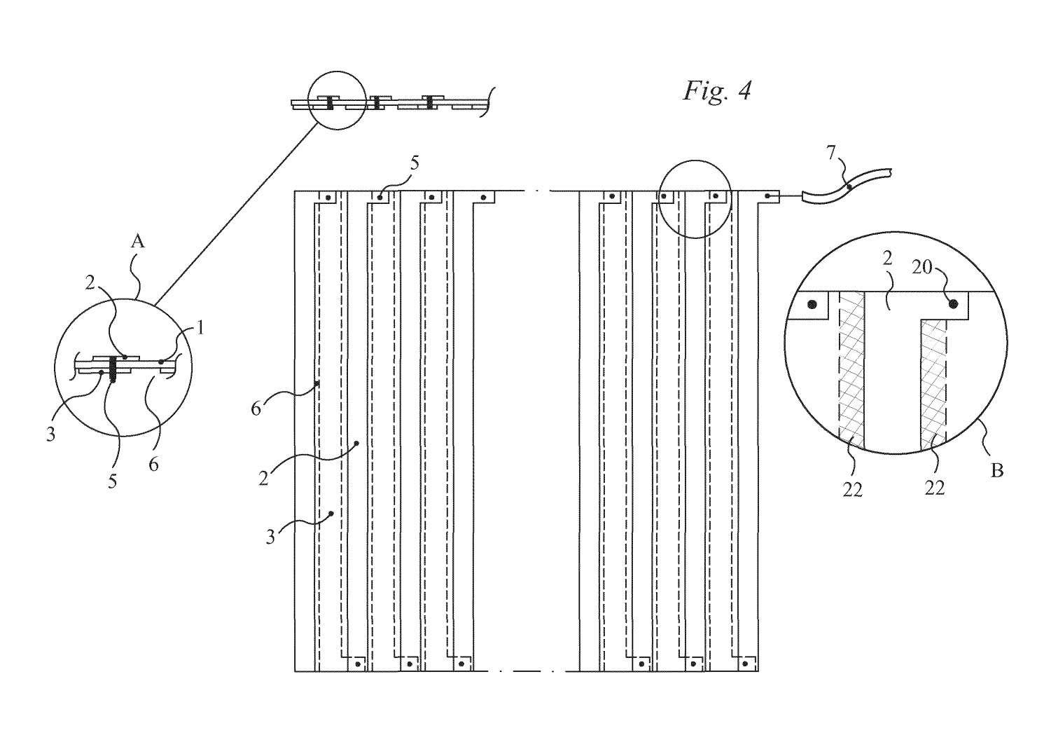

Electrodes such as that shown in FIG. 3 are typically used together with electrodes such as that shown in FIG. 4 so operation of the electrodes together will be described in greater detail below.

FIG. 4 shows an electrode similar to that shown in FIG. 3. In FIGS. 3 and 4 like reference numerals are used to indicate like elements. One main difference is that the conductive strips on the first major surface 10 no not overlap with the strips on the second major surface 12. This creates regions 22 of the insulator 1 which are not bounded on either side by a conductive strip 2, 3.

In the electrode arrangement shown in FIG. 4, the spacing 4 between adjacent strips on at least one of the surfaces 10, 12 is wider than the strips 2, 3, on the respective other surface 12, 10. As a result the strips 2, 3 do not overlap and there are gaps in the coverage of the insulator. These gaps provide regions 22 of the insulator 1 which are not covered by a conductor on either the first major surface 10 or the second major surface 12. Two of these regions 22 are cross hatched in inset B on the plan view of FIG. 4.

The flat coils shown in FIGS. 3 and 4 may be made by several processes. These include a PCB Technique, a Sputter technique and a wound-wire technique.

In the PCB technique a thin ceramic substrate is plated on both sides with a conductor (e.g. copper). The copper is coated with a photo etching polymer and the coil strips together with the plate-through holes to make the connections between the strips through the ceramic substrate are photo-etched. The plate is then chemically etched to create the coil strips and connections. The plate through-holes are soldered to make the connections. This technique can be applied to a flexible substrate such as a plastic to produce a flexible top and bottom electrode. Thus, if a flexible insulator is provided between the top and bottom coils can produce a flexible electrode head. This flexible head can be formed or wrapped around a sealed vessel or cavity to produce cold plasma and hence ozone from air (oxygen) trapped inside the vessel or cavity.

The copper coating may be created by sputtering. In sputtering type techniques the conductive strips may be laid down only on those regions where they are intended to remain (for example by masking the substrate).

To wind the electrodes using wire, rather than laminar conductors, to provide an electrode such as that described with reference to FIG. 3, in which the conductors overlap, a thin ceramic substrate has a thin insulated wire wound around its periphery to make a flat coil. The coil is wound so that all of the turns touch one another (close wound). In the case of an electrode such as that described with reference to FIG. 4, in which the conductors do not overlap, a thin ceramic substrate has a thin none insulated wire wound around its periphery to make a coil. The coil is wound so that all of the turns have gaps between them (open wound).

Flat coils can also be made without an insulating thin ceramic substrate—if a coil is close wound (all of the turns touch each other) with insulated wire in a cylindrical helix configuration and then the cylindrical coil is flattened by squashing it substantially flat. This provides an insulated flat coil without spaces between the conductors—such as that shown in FIG. 3 but without a substrate. If the coil is open wound with spaces between the turns (as opposed to close wound) this provides an insulated flat coil with spaces between the conductors.

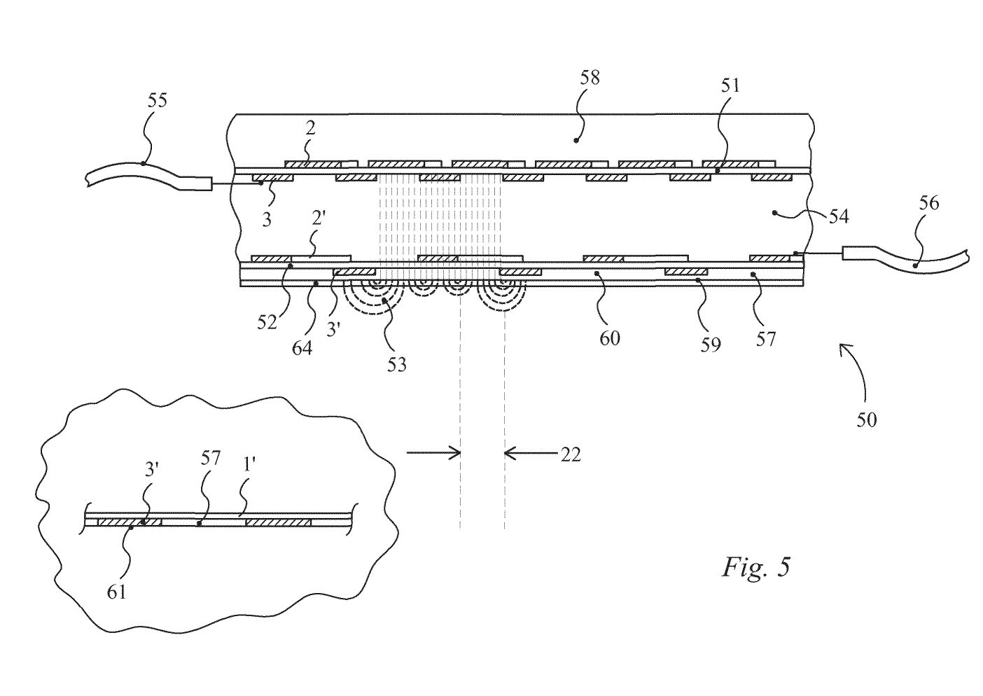

FIG. 5 shows an electrode head 50 comprising a first electrode 51 substantially as described above with reference to FIG. 3 and a second electrode 52 substantially as described above with reference to FIG. 4. The second electrode 52 provides a plate that comprises gaps 22 which allow electric field 53 to leak out from between the two plates (flat coil electrodes).

As shown in FIG. 5 the first electrode 51 is coupled to a power supply by a conductive coupling 55. In addition to the thin insulators 1, 1′ which support the flat wound coils of the electrodes 51, 52, a spacing insulator 54 is disposed between the two electrodes. Insulation 60 is also applied to a working surface of the electrode head 50. This insulation on the working surface includes two layers. A first layer 57 lies between the conductive strips 3′. A further covering 59 insulates the strips 3′ from the working surface. The layer 57 and the covering 60 may be contiguous (e.g. applied together) or they may be applied separately. As shown in inset A on FIG. 5, the layer of insulation 57 may be applied to the insulator 1′ of the second electrode 52 in a thickness equivalent to the thickness of the strips 3′ of the electrode.

The rear surface of the electrode head 50, opposite to the working surface is covered in a relatively thick layer of insulation 58. In FIG. 5 a layer of packaging 64 is shown adjacent the working surface insulation 57 of the electrode head 50.

The electrodes of FIG. 5 have the following dimensions.

The first electrode (the “top” electrode, without gap regions) comprises copper strips having a thickness of 0.1 mm and a width of 2 mm. The length of each strip is 50 mm across the width 16 of the electrode in FIG. 3. The insulator 1 which carries the strips is 0.2 mm thick. Thus the approximate area of the cross section of the coil is 75 mm² and the approximate inductance per unit length of electrode coil is 50 μH/M using a high permeability former. The length of coils of FIG. 5 (labelled 18 in FIGS. 3 and 4) is 50 mm.

In operation, a voltage difference is applied across the electrodes. The electric field 53 set up between the electrodes is able to extend out (leak) from the space between the electrodes through the regions 22 of the electrode 52 that are not covered by conductive strips. This electric field 53 is able to extend through the layer of packaging 64 into the interior of the packaging and thus enable the generation of plasma in the interior of the packaging. This

Preferably the ratio of the spacing 22 between coil turns to the width of the coil turns is at least 1.5 and is preferably less than 4. The inventors in the present case have found that where this ratio is less than 1.5 plasma generation becomes less efficient. A ratio of more than 4 requires excessively high voltage to set up the plasma.

Preferably the ratio of insulation thickness between the coils 10 and the insulation thickness covering the coil strip 9 is at least 1.5:1 and preferably the insulation thickness covering the coil strip 9 should be no more than 0.5 mm.

Preferably the coils are positioned such that one of the power supply leads is connected to the left hand side of one electrode 104 and the other lead is connected to the right hand side of the other coil 106. In this configuration the resistive and reactive impedance of the electrodes is advantageously spatially distributed. The right and left hand connections may also be reversed.

In operation the power supply 100 (in FIG. 1) may be configured to provide an AC voltage having a selected frequency and a controller may be provided to couple the electrode heads to the power supply for selected period of time so that the electric field is generated at the head in relatively short bursts. Typically the frequency of the AC voltage is 1 kHZ to 80 kHZ and the burst period is 0.1 sec to 1 sec. The amplitude of the voltage during the bursts is typically 7 kV to 18 kV peak and the power drawn by the electrode head 104,106 during these bursts is 50 Watts to 300 Watts.

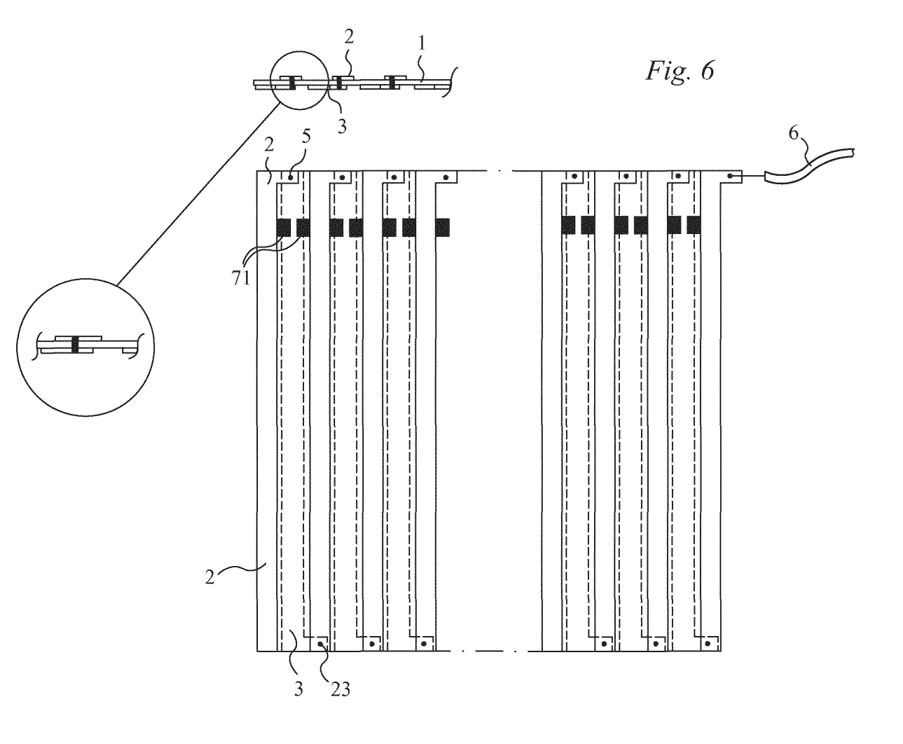

FIG. 6 shows an electrode similar to that shown in FIG. 4. In FIGS. 4 and 6 like reference numerals are used to indicate like elements. In FIG. 6, conductive elements 71 are arranged between the strips 2, 3 so as to provide a short circuit between adjacent turns of the coil. The conductive elements 71 are provided by controllable switches.

The electrodes 104, 106 of FIG. 1 and/or the electrodes 51, 52 may comprise these conductive elements.

In operation the inductance of the electrode(s) 51, 52, 104, 106 may be varied by switching the conductive elements on or off. When all the conductive elements 71 are switched on (conducting) all of the turns of the coil are shorted together so the inductance of the electrode is reduced. When all the conductive elements are switched off the complete electrode behaves as a coil so the inductance is at a maximum.

The strips 2, 3 of FIG. 6 are not overlapping but the conductive elements may be used in a similar way in electrodes with overlapping coil turns, e.g. as shown in FIG. 4. The conductive elements need not all be switchable and can be provided by soldering the turns of the coil together. The conductive elements may be provided by voltage controlled impedances, such as triacs. In this regard, devices with high power and/or voltage tolerance such as high power analogue switches may be preferred. Such an arrangement enables the reactive impedance of the electrode can be modulated on the fly during operation of the electrode. This may be of particular advantage where the contents and size of the packaged article 110 are variable.

For example, different packages (having different contents) will provide differing capacitive/inductive loading on the coil, to account for this it is possible to short circuit adjacent coils on one or more of the electrodes to reduce the inductive reactance of the electrode head 104, 106. A controller configured to control the conductive elements to provide a selected change in the inductance may be provided.

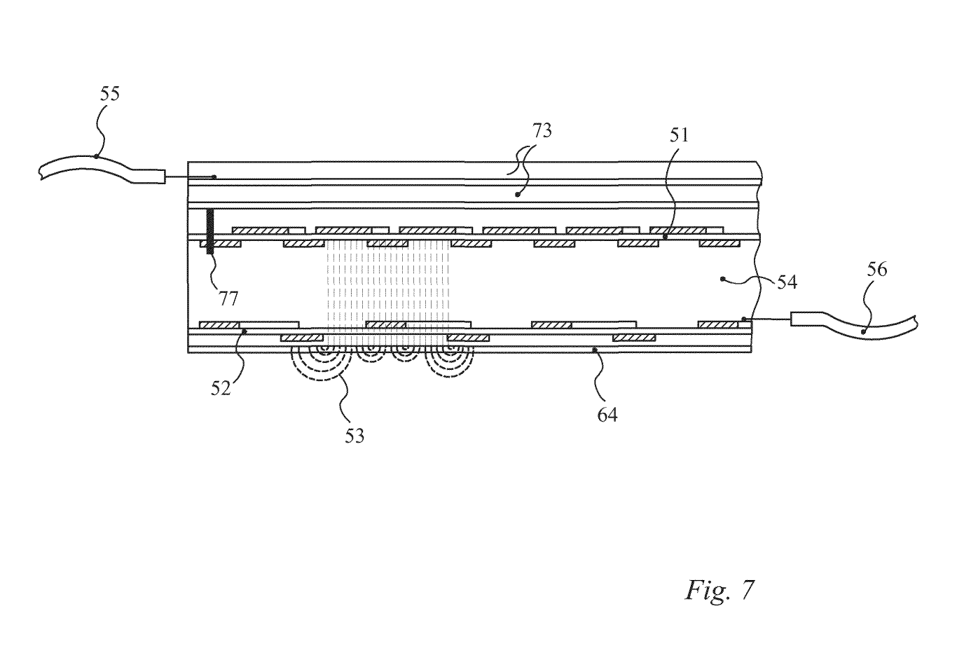

FIG. 7 shows a cross section of an electrode head similar to that shown in FIG. 5. In FIG. 5 and FIG. 7 like reference numerals are used to indicate like elements.

The electrodes 51, 52 of FIG. 7 are substantially as described above with reference to FIGS. 3, 4 and 5. In FIG. 7 a capacitor 73 is coupled in series between the power supply lead 55 and the electrode 51, the connection 77 passes through an insulator connects the strips to the bottom plate of the capacitor 73. This capacitor provides a capacitance such as that labelled 116 in FIG. 1.

In this configuration the electrode head is an integrated unit. However the capacitor 73 need not be provided as part of the head and may be provided as a separate component. In addition, in some cases the electrodes themselves need not be arranged as coils and may simply be capacitive. In these examples separate inductors and/or capacitors can be provided and may be positioned outside the electrode head instead of integrated into it. The down side of this is that the impedance is not distributed across the electrode and the inventor has found that this may reduce efficiency and increase heating of the electrode head.

Providing an integrated head has the advantage that there is no need to provide separate electrical components with cables between these components and the head. The inventors have found that the integrated electrode head provides more stable resonant operation because there is less (or at least more predictable) change in the inductive/capacitive loading of the electrode head from objects in the vicinity of the head and its power supply circuitry. This is of particular advantage where the electrode head may need to be moved (e.g. between different working areas). Stability is important in food treatment operations because the quantity of ozone produced depends upon the field conditions in the packages. Producing too much ozone may spoil the packaged contents whilst not producing enough may fail to sterilise the package. The PCB type process described above is of particular utility in this regard because it lends itself to integrating components and allows a simple installation.

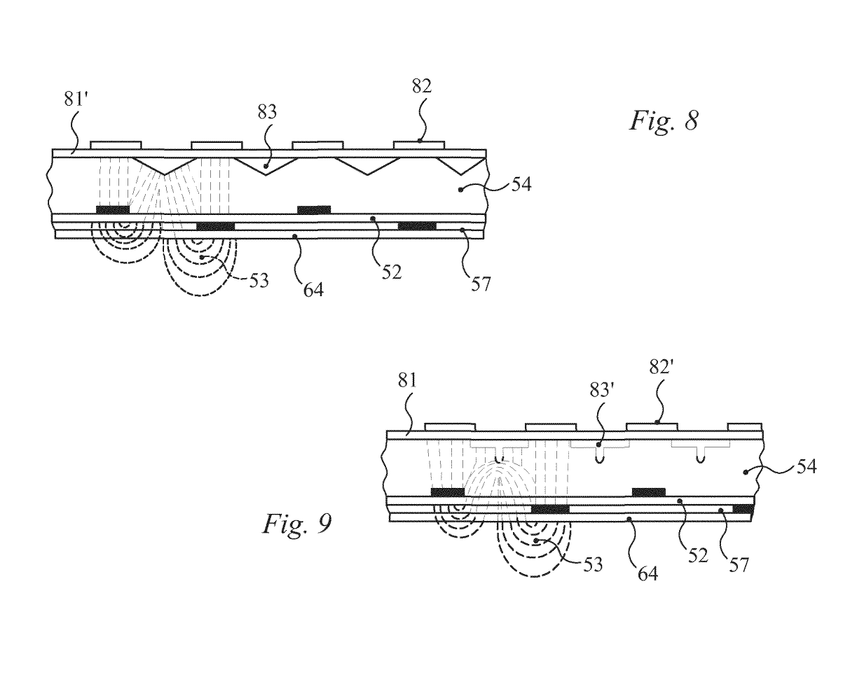

FIG. 8 and FIG. 9 each show a cross section through a part of an electrode head substantially similar to that shown in FIGS. 5 and 7. In these drawings like reference numerals are used to indicate like elements.

The electrode of FIG. 8 comprises a first electrode coil 52 which is similar to the electrode described above with reference to FIG. 5 having gap regions through which the electric field 53 is able to leak. The first electrode coil 52 separated from another electrode coil 51′ by an insulator 54. The electrode coil 51′ is substantially similar to that described above with reference to FIG. 3 and comprises conductive strips 83, 82 arranged on an insulator in the manner described above with reference to the strips 2, 3 shown in plan view in FIG. 3. The strips 83 which face the first electrode 52 are profiled to increase the electric field strength between the electrode coils 51′, 52. In FIG. 8 the strips 83 have a triangular cross section and the vertex of the triangle lies toward the other electrode 52. The vertex of the triangle is also arranged to coincide with the gaps 22 between the coils in the electrode 52 to promote leakage of the field through these gaps.

Similarly, the electrode of FIG. 9 comprises a first electrode coil 52 which is similar to the electrode described above with reference to FIG. 5 having gap regions through which the electric field 53 is able to leak. The first electrode coil 52 separated from another electrode coil 81 by an insulator 54. The electrode coil 81 is substantially similar to the electrode 51 described above with reference to FIG. 3 and comprises conductive strips 83, 82 arranged on an insulator in the manner described above with reference to the strips 2, 3 shown in plan view in FIG. 3. The strips 83 which face the first electrode 52 are profiled to increase the electric field strength between the electrode coils 51′, 52. In FIG. 9 the strips 83 comprise a protrusion which extends from the strips 83 toward the other electrode 52. Again, the protrusion on the strips is arranged to coincide with the gaps 22 in the other electrode.

In both of these examples the strips 83 are configured to provide increased electric field in regions where there are gaps in the other electrode. As will be appreciated, other strip profiles may be used and these are just two examples. The protrusions from the strips 83 may for example be continuous ridges which run along all or part of the strip 83. In some cases the protrusions may be spikes or points rather than ridges. The examples described with reference to FIG. 8 and FIG. 9 aim to increase the spatial derivative of the electric potential in regions which coincide with the gaps 22 in the other electrode, as will be understood other arrangements of conductors could achieve this result.

1. A packet steriliser for sterilising packaged articles, comprising:
a working surface arranged for receiving a packaged article to be sterilised;
a first electrode and a second electrode;
wherein the first electrode and the second electrode extend behind a portion of the area of the working surface and the first electrode is disposed between the second electrode and the working surface and the first electrode comprises a plurality of gaps arranged so that, in use, when a voltage difference is applied between the first electrode and the second electrode, the associated electric field is able to extend through the gaps beyond the working surface and into a package of said packaged article to be sterilised,
wherein the first electrode and the second electrode comprise adjacent extended surfaces which lie substantially along the direction of the working surface that provides a capacitance related to the adjacent spatial extent of the first electrode and the second electrode and an inductance is provided, wherein the inductance is selected based on that spatial extent to modify the resonant frequency of the electrode arrangement.

2. The packet steriliser of claim 1 comprising a dielectric arranged between the first electrode and the second electrode, the dielectric having a breakdown voltage of at least 20 kV per mm.

3. The packet steriliser of claim 1 wherein the dielectric is selected from a list comprising: boron nitride; shapal; mica; and synthetic mica such as synthetic flourophlogopite.

4. The packet steriliser of claim 1 in which at least one of the first electrode and the second electrode comprises the inductance, and wherein the at least one of the first electrode and the second electrode comprises a coil.

5. (canceled)

6. The packet steriliser of claim 1 in which the at least one electrode is arranged to provide a conductive path which traverses the extended surface of the at least one electrode to provide at least a part of said inductance.

7. The packet steriliser of claim 6 in which the conductive path is serpentine or coiled so that it repeatedly traverses the extended surface, and wherein the electrode is coiled.

8. (canceled)

9. The packet steriliser of claim 6 in which the at least one electrode comprises the first electrode and the conductive path is arranged to traverse the working surface between said gaps.

10. The packet steriliser of claim 1 in which at least one of the first and second electrodes comprises a planar insulator and a conductive material arranged to provide a conductive path along the surface of said insulator, and wherein the conductive material is arranged in a plurality of strips.

11. (canceled)

12. The packet steriliser of claim 11 in which the plurality of strips are conductively coupled at alternate ends to provide a path configured to be one of: folded, zig-zag, and serpentine.

13. (canceled)

14. The packet steriliser of claim 10 in which the conductive material comprises a layer and the layer is etched to provide the strips.

15. The packet steriliser of claim 14 in which the layer is deposited on or fixed to said insulator.

16. The packet steriliser of claim 10 in which both major surfaces of the insulator comprise strips of conductive material.

17. The packet steriliser of claim 16 in which the strips are substantially parallel to each other.

18. The packet steriliser of claim 16 in which strips arranged on opposite surfaces of the insulator are conductively coupled through the insulator at alternate ends of the strips to provide a coiled conductive path which traverses alternate surfaces of the insulator as it traverses the extended surface of the electrode, and wherein the strips of the second electrode are arranged so that strips on opposing surfaces of the insulator overlap.

19. (canceled)

20. The packet steriliser of claim 18 wherein at least some of the strips of the first electrode are arranged so that strips on opposite surfaces of the insulator do not overlap, thereby to provide said gaps.

21. The packet steriliser of claim 1 in which at least one of the electrodes is provided by an insulated wire arranged as a flattened coil.

22. The packet steriliser of claim 1 in which the inductance is adjustable and comprising a plurality of voltage controlled impedances for adjusting the inductance.

23-24. (canceled)

25. The packet steriliser of claim 1 comprising an additional capacitance coupled in series with one of said electrodes, and wherein the capacitance is integrated with the electrodes in a single unit.

26. (canceled)

27. The packet steriliser of claim 1 in which one of the first electrode and the second electrode is earthed.

28. A method of sterilising a packaged article comprising arranging a packaged article adjacent the working surface of a packet steriliser according to claim 1 and applying a voltage to said electrodes to generate ozone in said package.

29. (canceled)
